(19) United States
(12) Patent Application Publication
(10) Pub. No.: US 2009/0193067 A1
(43) Pub. Date: Jul. 30, 2009

(54) SERVER-BASED RECALCULATION OF VECTOR GRAPHICS

(75) Inventors: Abraham Mathew, Edmonds, WA (US); Heidi McAllister, Brier, WA (US); Michael Joe Woolf, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/022,297

(22) Filed: Jan. 30, 2008

(51) Int. Cl. G06G 7/22

(52) U.S. Cl. 708/809

(57) ABSTRACT

Technologies are described herein for recalculating data-bound vector graphics on a server computer. A drawing program allows formulas to define how external data is utilized modify the attributes of a shape. When a request is received to publish a drawing to a server computer, any formulas are converted to server-optimized formulas. Once the formulas have been converted to server-optimized formulas, a published drawing is generated that includes the server-optimized formulas, a representation of the drawing in a vector format, and data identifying bindings between shapes within the drawing and external data. When a request to view the published drawing is received, the data bindings for the drawing are refreshed. The server-optimized formulas are then recalculated using updated values to generate new values for the shape attributes. The vector representation of the drawing is then updated with the new values and rasterized for display in a browser.

### BACKGROUND

Conventional drawing programs generally allow the creation and editing of drawings by providing a variety of shapes that can be selected and placed within the drawings. For instance, shapes such as squares, rectangles, circles, triangles, and other types of shapes may be placed within a drawing. Tools are also typically provided for orienting and sizing the shapes in the diagram as desired. Other tools may also be provided for drawing other types of shapes and performing other types of drawing functions.

Some conventional drawing programs provide a feature that allows data to be associated with the shapes in a drawing. For example, functionality may be provided for associating data stored at an external data source with the various attributes of a shape. In this way, the value of the external data may be utilized to specify the color, size, position, text, or other attributes of a shape within a drawing. External data may also be displayed in shapes as an additional visual element, such as an icon or a progress bar, which is displayed on or adjacent to the shape.

A formula may also be specified that defines how the value of the external data modifies the attributes of a shape. For instance, a formula may be defined that specifies that the color of the shape is red if a sales value retrieved from an external database is less than a specified value. Another formula may be defined that specifies that the color of the shape is to be set to green when the sales value retrieved from the external database is greater than the specified value. Formulas may also perform additional computations on any value, including external data values, and allow the attribute for one shape to be specified by the value of an attribute for another shape.

In addition to the creation of drawings, drawing programs also allow users to view and edit drawings created by other users using the same application or a compatible application. However, in order to view and edit a drawing created by another user, the appropriate drawing program utilized to create the drawing, or a compatible drawing program, must typically be installed on the computer on which the drawing is to be viewed.

In many cases, a user may simply be unable to view a drawing if they do not have a copy of the application program utilized to create the drawing installed on their computer. In other cases, a user may need to locate, download, and install a compatible viewer application program for displaying the drawing on their computer in order to view the drawing. It may, however, be difficult for a user to locate, install, and execute such a viewer application. In yet other cases, a compatible version of the application program or viewer application may not be available for the type of device on which the user wishes to view the document. For instance, a user may wish to view a drawing on a personal digital assistant (“PDA”) or a wireless mobile telephone for which a version of the application program utilized to create the drawing or a viewer application does not exist.

In some cases, the drawing program may provide functionality for exporting a drawing as a picture or World Wide Web page, which will allow other users to view the drawing. However, these types of exported pictures are static and, as a result, any externally referenced data will not change and the graphics cannot be modified based upon changes in the external data. This can be extremely frustrating for a user that has a need to view a drawing, including updating attributes for any shapes connected to external data contained therein, but who does not possess the necessary application program utilized to create the drawing or a compatible viewer application.

It is with respect to these considerations and others that the disclosure made herein is presented.

### SUMMARY

Technologies are described herein for recalculating vector graphics on a server computer. In particular, through the utilization of the technologies and concepts presented herein, a drawing containing one or more shapes bound to external data sources can be rendered on a server computer for display using a standard viewer application program executing on a client computer, such as a world wide web (“web”) browser application. Because the drawing is recalculated and rendered on the server computer, including any data-bound shapes contained therein, there is no need for the application program utilized to create the drawing or a specific viewer application for the drawing to be installed on the client computer.

According to one aspect presented herein, a drawing program executing on a client computer provides functionality for creating a drawing that includes shapes with attributes bound to external data sources. The drawing program also provides functionality for defining formulas that define how the external data is to be utilized modify the attributes of a shape. In this regard, the formulas may reference data provided by external data sources.

The drawing program also provides functionality for publishing a drawing to a server computer. When a request is received to publish a drawing to a server computer, any formulas utilized to modify shape attributes are converted to server-optimized formulas. This process reduces the formulas to the minimum necessary for recalculation on the server computer. For instance, conversion of the formulas to server-optimized formulas may include reducing a formula to a constant where possible, removing functions from the formulas that are not supported by the server computer, and reducing other formula elements to constants where possible. Once the formulas have been converted to server-optimized formulas, a published drawing is generated that includes the server-optimized formulas, a representation of the drawing in a vector format, and data identifying bindings between shapes within the drawing and external data. The drawing program publishes the published drawing to a server computer.

A request may be received at the server computer to view the published drawing. Such a request may be generated by a standard viewer application, such as a web browser application program, executing on a client computer. When such a request is received, the server computer refreshes the data bindings for the drawing by obtaining updated values for any external data. The server-optimized formulas are then recalculated using the updated values to generate new values for the shape attributes. The vector representation of the drawing is then updated with the new values. For instance, in one embodiment the vector representation of the drawing is represented in a markup language. In this embodiment, the vector representation of the drawing is updated with new values for the shape attributes by replacing or modifying markup language elements corresponding to the attributes within the vector representation.

Once the vector representation of the drawing has been updated with the updated values for the shape attributes, the vector representation of the drawing is either sent directly to a viewer application for display by a plug-in or rasterized to generate a rasterized drawing in a standard image format. The rasterized drawing is then returned to the viewer application for display. In this manner, a drawing containing shapes bound to an external data source is rendered on the server computer for display by the standard viewer application program executing on the client computer.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a combined network and software architecture diagram showing aspects of an illustrative operating environment and several software components provided by the embodiments presented herein;

FIG. 2 is a combined screen and data structure diagram showing aspects of a drawing and a shape sheet utilized in the embodiments presented herein;

FIG. 3 is a flow diagram showing aspects of one embodiment provided herein for publishing a drawing to a server computer and recalculating the drawing on the server computer;

FIGS. 4A-4B are flow diagrams showing an illustrative routine for generating server-optimized formulas in one embodiment presented herein;

FIGS. 5A-5B are flow diagrams showing an illustrative routine for recalculating attributes for data-bound shapes and text in one embodiment provided herein; and

FIG. 6 is a computer architecture diagram showing an illustrative computer hardware and software architecture for a computing system capable of implementing aspects of the embodiments presented herein.

### DETAILED DESCRIPTION

The following detailed description is directed to technologies for recalculating vector graphics on a server computer. Through the use of the technologies and concepts presented herein, a drawing can be created on a client computer, published to a server computer, and rendered on the server computer for display using a standard viewer application program. Because the published drawing is recalculated and rendered on the server computer, including any data-bound shapes contained therein, the application program utilized to create the drawing is not needed in order to view the published drawing. Rather, a standard viewer application, like a Web browser, can be utilized to view the published drawing.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for recalculating vector graphics on a server computer will be described.

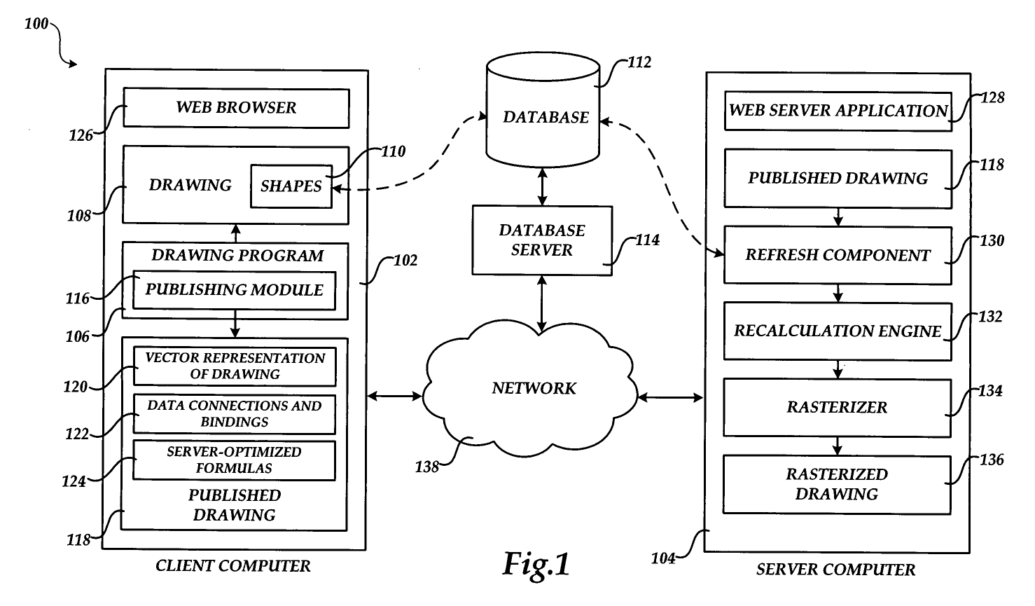

Turning now to FIG. 1, details will be provided regarding an illustrative operating environment and several software components provided by the embodiments presented herein. In particular, FIG. 1 shows aspects of a system 100 for server-based recalculation of a vector representation of a drawing. The system 100 includes a client computer 102 and a server computer 104. The client computer 102 comprises a standard desktop, laptop, or handheld computing system capable of executing the drawing program 106 and a web browser 126.

As will be described in greater detail herein, the drawing program 106 comprises an executable application program capable of creating a drawing 108. The drawing 108 may include a multitude of visual elements laid out in virtually in any format. In particular, the drawing 108 may include one or more shapes 110. The shapes 110 may be bound to an external data source. For instance, various attributes of the shapes 110, such as the color, size, position, shape text, or orientation, may be linked to an external data source, such as the database 112 provided by the database server 114. In this manner, the visual appearance of the shapes 110 can be driven by the data retrieved from the database 112. The drawing program 106 may also provide functionality for binding the attributes of the shapes 110 to other types of data sources in addition to database 112. For instance, the attributes of the shapes 110 may be bound to a spreadsheet, a list, or another type of data source external to the drawing program 106.

As will also be described in greater detail below, the drawing program 106 may also provide functionality for allowing a user to specify a formula that references an external data source and indicates how the value of the external data may be utilized to modify the attributes of the shapes 110. For instance, a user may utilize the drawing program 106 to specify a formula that changes the color of one of the shapes 110 depending on the value retrieved from the database 112. Other formulas may be defined that specify how other types of attributes of the shapes 110 are to be modified based upon the retrieved external data. The formulas may include references to other formulas, data binding references to data values stored in an external data source, and functions. Additional details regarding the functionality provided by the formulas will be described below.

In one embodiment presented herein, the drawing program 106 also provides functionality for publishing the drawing 108 to a server computer 104. In particular, a drawing 108 having one or more shapes 110 with attributes defined by a formula that references external data may be published to the server computer 104. In order to publish the drawing 108 to the server computer 104, the drawing program 106 utilizes a publishing module 116. In response to receiving a request to publish the drawing 108 to the server computer 104, such as from a user, the publishing module 116 is executed.

As will be described in greater below, the publishing module 106 is operative to generate a published drawing 118 that is published to the server computer 104. In order to generate the published drawing 118, the publishing module 106 generates server-optimized formulas 124 for any formulas within the drawing 108 that reference external data. The server-optimized formulas 124 are compact formulas that are suitable for evaluation by the server computer 104. Details regarding the generation of the server-optimized formulas 124 are provided below with respect to FIGS. 4A-4B.

The publishing module 116 also generates a vector representation 120 of the drawing 108. The vector representation 120 comprises a representation of the drawing 108 in an intermediate graphics format. In one implementation, the vector representation 120 is expressed utilizing the SILVERLIGHT EXTENSIBLE APPLICATION MARKUP LANGUAGE (“XAML”) from MICROSOFT CORPORATION of Redmond, Wash. It should be appreciated however that other types of languages for describing vector graphics may also be utilized. As illustrated in FIG. 1, the published drawing 118 also includes data connections and bindings 122. The data connections and bindings 122 comprises data that identifies the connections or bindings between shapes 110 contained in the drawing 108 and external data sources, such as the database 112.

Once the publishing module 116 has generated the vector representation 120 of the drawing 108, the data connections and bindings 122, and the server-optimized formulas 124, these items are transmitted to the server computer 104 via a communications network, such as the network 138. The server computer 104 stores the published drawing 118 in an appropriate mass storage device.

According to other aspects presented herein, the server computer 104 may also receive and respond to requests from a client computer 102 to view the published drawing 118. Such a request may be received by a web server application 128 from a web browser 126 executing on the client computer 102. Although the web browser 126 has been illustrated in FIG. 1 as executing on the same client computer 102 as the drawing program 106, the web browser 126 may be utilized on another client computer or other type of computing device that does not have the drawing program 106 installed thereupon.

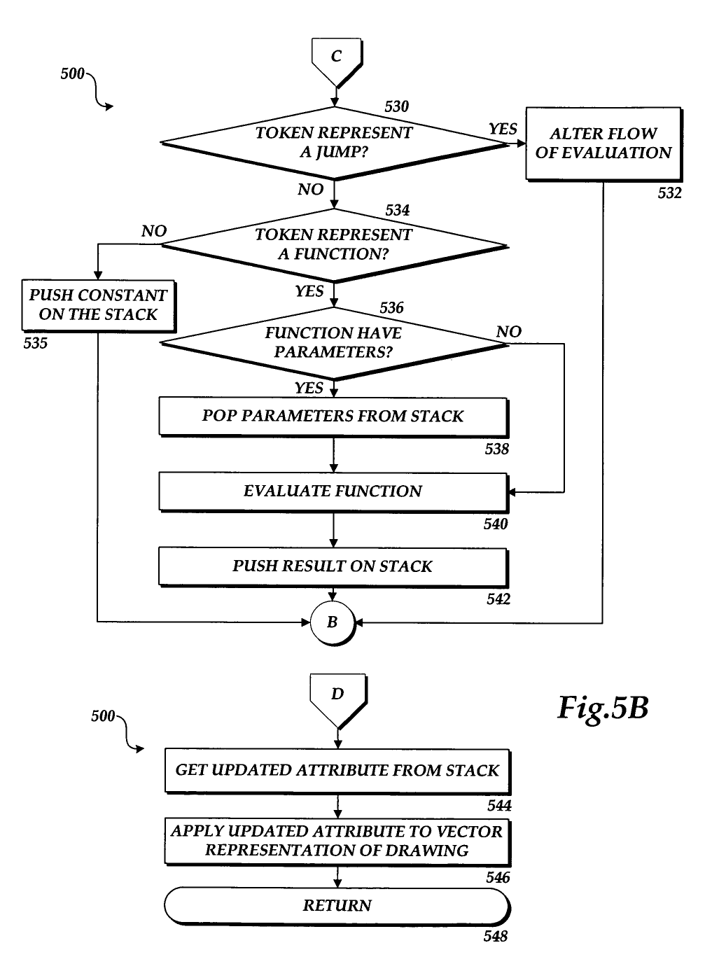

In response to receiving a request to view the published drawing 118, the server computer 104 executes a refresh component 130. The refresh component 130 is operative to utilize the data connections and bindings 122 to obtain updated values for externally referenced data. For instance, in the example shown in FIG. 1, the refresh component 130 communicates with the database 112 to update the values for attributes in the drawing 108 that reference the database 112. Once updated values have been obtained, a recalculation engine 132 is executed that evaluates the server-optimized formulas 124 with the updated values for the shape attributes obtained by the refresh component 130. Details regarding the execution of the recalculation engine 132 are provided below with respect to FIGS. 5A-5B. When the recalculation engine 132 has completed evaluating the server-optimized formulas 124 to obtain the updated values for the external data, the recalculation engine updates a portion of the vector representation 120 of the drawing 108 to reflect the updated values. For instance, attributes or other markup language elements contained within the vector representation 120 may be replaced or modified to specify the updated value for the attribute.

Once the recalculation engine 132 has updated the vector representation 120 of the drawing 108, a rasterizer 134 is executed to rasterize the vector representation 120 into a rasterized drawing 136. In one implementation, the rasterized drawing 136 is stored in a standard image format, such as the portable network graphics (“PNG”) image format, that may be displayed without the assistance of a plug-in module by a standard viewer application, such as the web browser 126. The rasterized drawing 136 is returned to the web browser 126 in response to the original request to view the published drawing 118 received at the server computer 104. Additional details regarding the processes performed by the client computer 102 for publishing the drawing 108 and by the server computer 104 for refreshing, recalculating, and rasterizing the published drawing 118 are provided below.

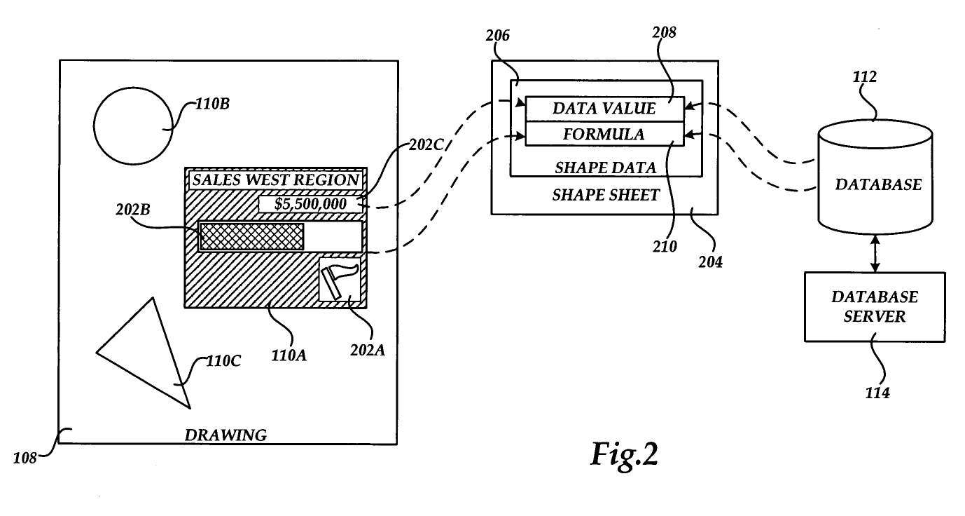

Referring now to FIG. 2, additional details regarding the functionality provided by the drawing program 106 for creating a drawing 108 and associating shapes 110A-110C within the drawing 108 to external data will be described. In particular, FIG. 2 shows the contents of an illustrative drawing 108. The drawing 108 illustrated in FIG. 2 includes the shapes 110A, 110B, and 110C. Each of the shapes 110A-110C include a number of attributes that specify the visual appearance for the shape. As described briefly above, these attributes can be bound to external data, such as data stored in a database 112, controlled by the database server 114. For example, the shape 110A has a color attribute that has been bound to external data. The external data is specified within a shape sheet 204 that is maintained by the drawing program 106. In particular, the shape sheet 204 includes shape data 206 that specifies data indicating how the various attributes of the shapes 110A-110C are to be displayed.

In the example shown in FIG. 2, the shape 110A has its color attribute bound to a formula 210 specified within the shape sheet 204. In this example, the formula references external data contained in the database 112. For instance, the formula 210 may specify that the color attribute of the shape 110A be set to red if the external data retrieved from the database 112 is greater than a predefined number. In this example, the shape 110A also includes text 202C that is bound to a data value 208 retrieved from the database 112. In this example, the text 202C corresponds to a numeric data value 208. It should be appreciated that a text attribute of the shape 110A may be bound to an external text value in a similar manner. In one embodiment, formulas reference shape data 206 cells that are bound to external data through a data linking mechanism.

According to aspects, the shapes 110A-110C may also include graphical elements that are displayed in accordance with data retrieved from an external data source. These graphical elements are referred to herein as “data graphics.” For instance, the shape 110A illustrated in FIG. 2 includes a data bar 202B that varies depending upon the value of a referenced external data value or formula containing a reference to an external data value. A flag icon 202A, or other type of icon, may also be displayed in conjunction with the shape 110A with its attributes varying based upon an external data value or formula. It should be appreciated that any attribute of a shape 110A-110C may be specified based upon a bound data value 208 or a formula 210 that includes bound data values. It should also be appreciated that the externally referenced data values may be updated in an automated or manual fashion by the drawing program 106 to provide an updated data value for defining the attributes of the shapes 110A-110C. Methodologies are provided below for updating the external data values prior to rendering the drawing 108 at the server computer 104.

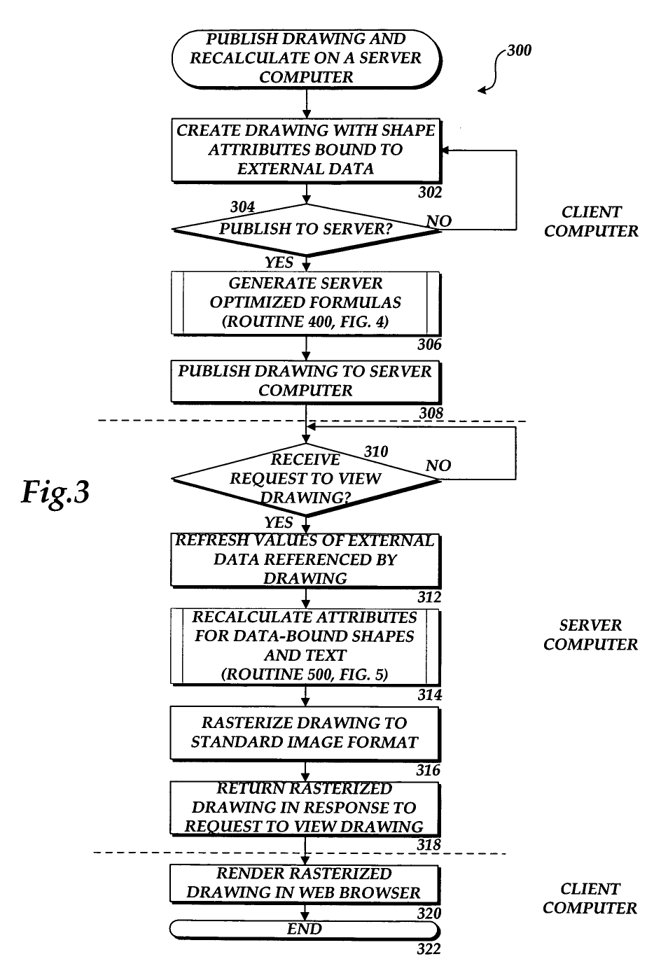

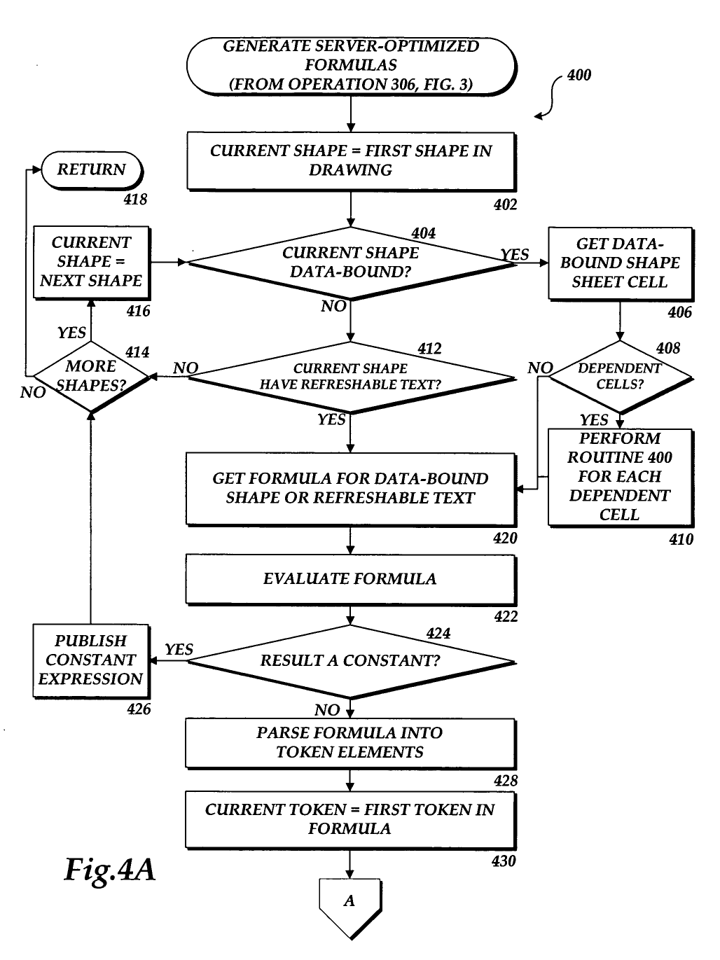

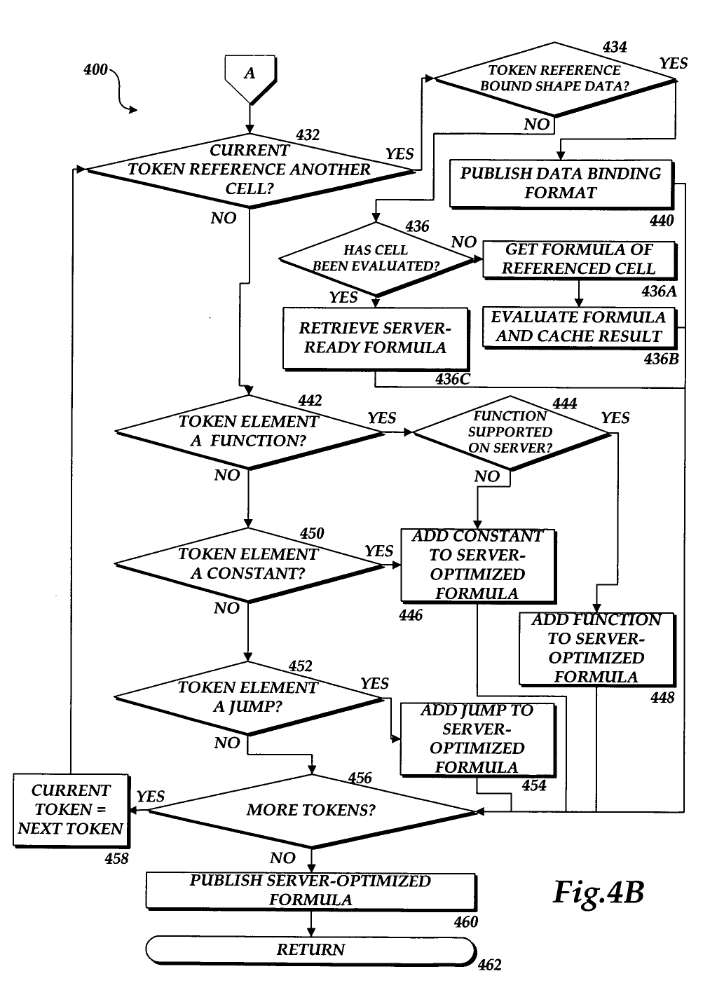

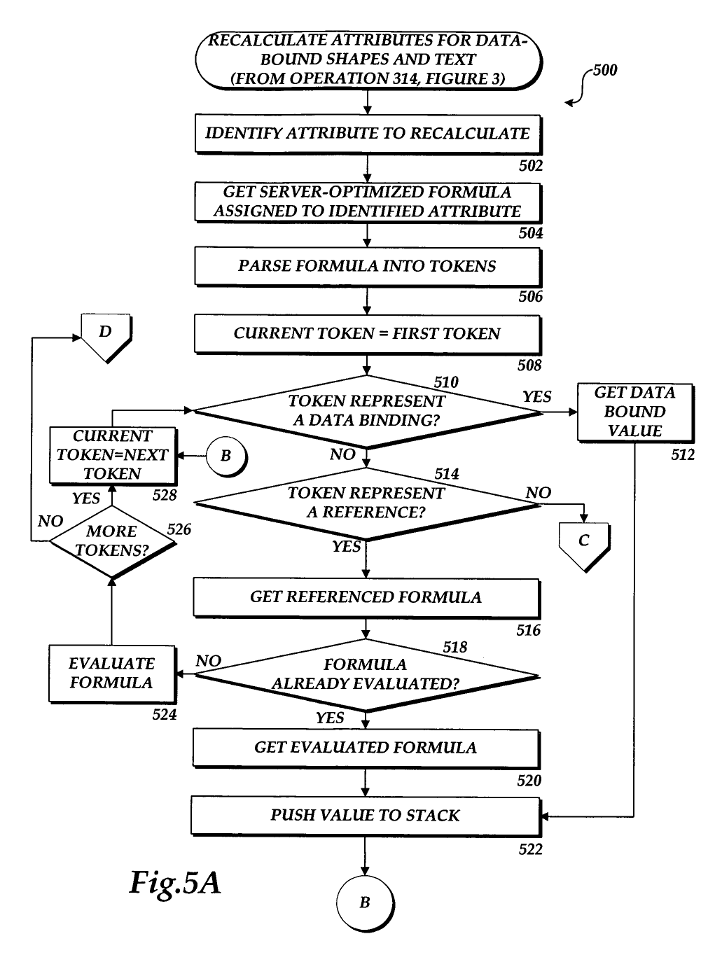

Referring now to FIG. 3, additional details will be provided regarding the embodiments presented herein for recalculating vector graphics on a server computer 104. In particular, FIG. 3 is a flow diagram showing a routine 300 that illustrates aspects of the operation of the client computer 102 for publishing a drawing to the server computer 104 and aspects of the operation of the server computer 104 for recalculating the drawing 108 in one embodiment. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 300 begins at operation 302, where the drawing program 106 is utilized to create a drawing 108 that includes shapes 110 that have attributes bound to external data or that includes attributes that are defined by a formula that references external data. It should be appreciated that, in embodiments, a formula may also comprise a refreshable value when evaluated. For instance, a “now” function may provide the current time and data when refreshed. This functionality is generally applied to refreshable text fields.

From operation 302, the routine 300 continues to operation 304, where the drawing program 106 determines whether a request has been received to publish the drawing 108 to the server computer 104. In the absence of such a request, the routine 300 returns to operation 302, where the functionality for creating and editing the drawing 108 is continually provided. If a request is received to publish the drawing 108 to the server computer 104, the routine 300 continues to operation 306.

At operation 306, the publishing module 116 identifies any formulas contained within the drawing 108 that reference external data. These formulas are then converted to the server-optimized formulas 124. It should be appreciated that, in embodiments, each formula that has a function that can be evaluated at the server computer will be converted to a server-optimized formula, even if the formula does not reference external data. An illustrative routine 400 will described below with reference to FIGS. 4A-4B for converting the formulas within the drawing 108 to server-optimized formulas 124.

From operation 306, the routine 300 continues to operation 308 where the publishing module 116 publishes the published drawing 118 to the server computer 104. As discussed above, the published drawing 118 includes the vector representation 120 of the drawing 108, the data connections and bindings 122, and the server-optimized formulas 124. In one implementation, the drawing 108 may also be published to the server computer 104 in a native format along with the published drawing 118.

As discussed above, when the server computer 104 receives the published drawing 118, the published drawing 118 is stored in an appropriate mass storage device. The server computer 104 may then receive and respond to requests to view the published drawing 118, such as from the web browser 126. The web server application 128 receives and responds to such requests by executing the various software components described herein. If a new request is received to view the published drawing 108, the routine 300 continues from operation 310 to operation 312.

At operation 312, the refresh component 130 obtains updated values for the externally referenced data. For instance, the refresh component 130 may utilize the data connections and bindings 122 to obtain updated values from the database 112. Once the refresh data has been obtained, the routine 300 continues to operation 314. At operation 314, the recalculation engine 132 is executed and recalculates the values for any attributes within the drawing 108 that are connected to externally bound data or that contain recalculable server-supported functions. In particular, the recalculation engine 132 evaluates the server-optimized formulas 124 utilizing the updated data values obtained from the external data sources by the refresh component 130. An illustrative routine 500 will be described below with reference to FIGS. 5A-5B for recalculating the shape attributes and updating the vector representation 120 with the updated attributes.

Once the attributes have been updated, the routine 300 continues from operation 314 to operation 316, where the rasterizer 134 rasterizes the published drawing 118 into a rasterized drawing 136 in a standard image format. Once the rasterized drawing 136 has been generated, the routine 300 continues to operation 318 where the rasterized drawing 136 is returned to the web browser 126 in response to the original request to view the published drawing 118. The web browser 126 receives the rasterized drawing 136 at operation 320 and displays the rasterized drawing 136. The routine 300 then continues from operation 320 to operation 322, where it ends.

Referring now to FIGS. 4A-4B, an illustrative routine 400 will be described for generating the server-optimized formulas 124. As discussed briefly above, the publishing module 116 generates a server-optimized formula for each of the formulas in the drawing 108 that reference external data at time the drawing 108 is published. The routine 400 illustrates one method performed by the publishing module 116 to generate the server-optimized formulas 124. It should be appreciated that, in one embodiment, the server-optimized formulas 124 are expressed in a post-fix notation using a markup language, such as the extensible markup language (“XML”). It should be appreciated, however, that other data formats may be utilized to express the server-optimized formulas 124.

The routine 400 begins at operation 402 where a variable corresponding to a current shape is set equal to the first shape in the drawing 108. The routine 400 then continues to operation 404 where a determination is made as to whether the current shape is bound to external data. If the current shape is bound to external data, the routine 400 proceeds from operation 404 to operation 406, where a cell in the shape sheet 204 containing the binding is identified. Once the binding has been identified, the routine 406 continues to operation 408 where a determination is made as to whether there any cells in the shape sheet 204 that depend upon the identified cell. If dependent cells are located, the routine 400 proceeds from operation 408 to operation 410, where the routine 400 is called recursively to generate server-optimized formulas contained in any dependent cells. If no dependent cells are located, the routine 400 proceeds from operation 408 to operation 420, described below.

If, at operation 404, it is determined that the current shape 110 is not data bound, the routine 400 continues to operation 412. At operation 412, a determination is made as to whether the current shape has refreshable text. Refreshable text comprises text that is bound to external data or a recalculable server-supported function. If the current shape does not have refreshable text, the routine 400 branches to operation 414, where a determination is made as to whether any additional shapes 110 remain in the drawing 108 to be processed. If additional shapes remain, the routine 400 proceeds from operation 414 to operation 416 where the variable for the current shape is set equal to the next shape 110 in the drawing 108. If no more shapes exist to be processed, the routine 400 proceeds from operation 414 to operation 418, where it returns to the operation 308, described above with reference to FIG. 3.

If, at operation 412, it is determined that the current shape has refreshable text, the routine 400 proceeds from operation 412 to operation 420. At operation 420 the formula for the data bound shape or refreshable text is obtained from the shape sheet 204. The routine 420 then continues to operation 422 where the formula is evaluated. Once the formula has been evaluated, the routine 400 continues to operation 424 where a determination is made as to whether the formula evaluated to a constant. If the formula evaluates to a constant, the routine 400 proceeds from operation 424 to operation 426. At operation 426, the constant is published as a server-optimized formula 124. In this way, a formula that evaluates to a constant will not need to be recalculated by the server computer 104 at the time the published drawing 118 is rendered. From operation 426, the routine 400 proceeds to operation 414, described above.

If, at operation 424, it is determined that the formula did not evaluate to a constant, the routine 400 proceeds to operation 428. At operation 428, the publishing module 116 parses the formula into its token elements. Token elements comprise the various constituent parts of a formula and may include internal formula references, data binding references, and function references. Once the formula has been parsed into its token elements, the routine 400 continues to operation 430. At operation 430, a variable corresponding to a current token is set equivalent to the first token in the formula. The routine 400 then continues to operation 432, where a determination is made as to whether the current token references another cell in the shape sheet 204. If the current token references another cell, the routine 400 branches from operation 432 to operation 434 where a determination is made as to whether the current token references bound shape data. If so, the routine 400 proceeds from operation 434 to operation 440, where the reference to the bound data value is added to the server-optimized formula 124. From operation 440, the routine 400 continues to operation 456 described below.

If, at operation 434 it is determined that the current token does not reference bound shape data, the routine 400 proceeds from operation 434 to operation 436. At operation 436, a determination is made as to whether the contents of the current cell have been previously evaluated. A cache may be utilized to store evaluated formulas for later lookup. If the cell has already been evaluated, the routine 400 proceeds from operation 436 to operation 436C where the previously evaluated formula is retrieved from the cache. If the cell has not already been evaluated, the routine 400 proceeds from operation 436 to operation 436A, where the formula of the referenced cell is obtained. The routine 400 then continues to operation 436B, where the formula is evaluated in the manner described above with reference to operation 422. From operations 436C and 436B, the routine 400 then continues to operation 456, described below.

If, at operation 432, it is determined that the current token does not reference another cell, the routine 400 proceeds from operation 432 to operation 442. At operation 442, a determination is made as to whether the current token represents a function. If so, the routine 400 branches from operation 442 to operation 444, where a determination is made as to whether the function is supported for evaluation on the server computer 104. If the function is supported for evaluation on the server computer 104, the routine 400 branches from operation 444 to operation 448 where the function is added to the server-optimized formula 124 that is currently under evaluation. If, at operation 444, it is determined that the function is not supported by the server computer 104, the routine 400 proceeds from operation 444 to operation 446 where the function is reduced to a constant and added to the server-optimized formula 124. From operation 446, the routine 400 continues to operation 456, described below.

If, at operation 442, it is determined that the current token element does not represent a function, the routine 400 continues from operation 442 to operation 450. At operation 450, a determination is made as to whether the current token element is a constant value. If the current token element is a constant value, the routine 400 branches from operation 450 to operation 446 where the constant value is added to the server-optimized formula 124. If the current token element is not a constant, the routine 400 proceeds from operation 450 to operation 452.

At operation 452, a determination is made as to whether the current token element represents a jump. A jump is a token element that would cause the sequence of evaluation for the current formula to be altered. For instance, a jump may comprise an “if then, else” type operator. If so, the jump is added to the server-optimized formula 124 at operation 454. If the token element is not a jump, the routine 400 proceeds from operation 452 to operation 456.

At operation 456, a determination is made as to whether any additional tokens remain to be evaluated for the current formula. If so, the routine 400 branches from operation 456 to operation 458 where the variable corresponding to the current token is set to the next token element in the current formula. From operation 458, the routine 400 returns to operation 432, described above. If no additional tokens remain to be evaluated, the routine 400 proceeds from operation 456 to operation 460 where the generated server-optimized formula 124 is stored in the published drawing 118. As mentioned above, the generated server-optimized formula 124 may also be cached for later use in evaluating other cells. From operation 460, the routine 400 proceeds to operation 462, where it returns to the operation 308, described above with reference to FIG. 3.

Referring now to FIGS. 5A-5B, a routine 500 will be described illustrating one process performed by the recalculation engine 132 for recalculating the attributes for any data bound shapes 110 or text contained within a published drawing 118. In particular, the routine 500 begins at operation 502, where the attribute for a shape 110 within the published drawing 118 is identified for recalculation. Once the attribute has been identified, the routine 500 continues to operation 504 where the server-optimized formula 124 assigned to the identified attribute is retrieved from the published drawing 118. The routine 500 then continues to operation 506, where the server-optimized formula 124 is parsed into its constituent tokens. From operation 506, the routine 500 continues to operation 508 where the variable utilized to maintain the status of the current token is set equal to the first token in the server-optimized formula 124.

From operation 508, the routine 500 continues to operation 510 where a determination is made as to whether the current token represents a binding to an external data value. If the current token represents a data binding, the routine 500 proceeds from operation 510 to operation 512 where the data bound value is obtained. As discussed above, the refresh component 130 obtains the updated data bound values prior to recalculating the server-optimized formulas 124. From operation 512, the routine 500 proceeds to operation 522, described below.

If, at operation 510, it is determined that the current token does not represent a data binding, the routine 500 proceeds to operation 514. At operation 514, a determination is made as to whether the current token represents a reference, such a reference to another formula. If the current token does represent a reference, the routine 500 proceeds to operation 516 where the referenced formula is obtained. The routine 500 then continues to operation 518 where a determination is made as to whether the referenced formula has already been evaluated. If not, the routine 500 branches to operation 524, where the formula is evaluated. The routine 500 then continues to operation 526 where a determination is made as whether any additional tokens within the current formula remain to be evaluated. If so, the routine 500 proceeds from operation 526 to operation 528, where the variable utilized to maintain the status of the current token is set equal to the next token in the current formula. If no more tokens remain to be processed, the routine 500 proceeds from operation 526 to operation 544, described below.

If, at operation 518, it is determined that the referenced formula has already been evaluated, the routine 500 proceeds to operation 520 where the results of the formula evaluation are retrieved. The routine 500 then continues to operation 522, where the corresponding value is pushed onto an evaluation stack utilized by the recalculation engine 132 to evaluate the server-optimized formulas 124. From operation 522, the routine 500 proceeds to operation 528, described above.

If, at operation 514, described above, it is determined that the current token does not represent a reference, the routine 500 proceeds from operation 514 to operation 530. At operation 530, a determination is made as to whether the current token represents a jump. If so, the routine 500 proceeds to operation 532 where the flow of operation is altered based upon the jump. From operation 532, the routine 500 returns to operation 528, described above.

If, at operation 530, it is determined that the current token does not represent a jump, the routine 500 continues to operation 534 where a determination is made as to whether the current token represents a function. If the current token does not represent a function, the routine 500 proceeds from operation 534 to operation 535. Since the current token does not represent a jump, reference, binding, or formula, it is a constant. As a result, the constant is placed on the stack at operation 535. The routine 500 then continues to operation 528, described above.

If it is determined at operation 534 that the current token does represent a function, the routine 500 proceeds to operation 536 where a determination is made as to whether the function requires any parameters. If the function does not require parameters, the routine 500 branches to operation 540, described below. If the function does require parameters, the routine 500 proceeds from operation 536, to operation 538 where the necessary parameters are popped from the evaluation stack. The routine 500 then continues to operation 540 where the function is evaluated and the result of the function evaluation is placed onto the evaluation stack at operation 542. From operation 542, the routine 500 returns to operation 528, described above.

If, at operation 526, it is determined that no additional tokens remain in the current formula to be processed, the routine 500 proceeds from operation 526 to operation 544. At operation 544, the value currently on the stack is retrieved as the value of the updated attribute. The routine 500 then continues to operation 546, where the updated attribute is applied to the vector representation 120 of the drawing 546. As discussed above, the vector representation 120 of the drawing 108 is represented in a markup language in one embodiment. In this embodiment updating the vector representation 120 with the updated value for the attribute includes updating a markup language element within the markup language with the updated value for the attribute. Once the vector representation 120 has been updated, the routine 500 proceeds from operation 546 to operation 548, where it returns to the operation 316, described above with reference to FIG. 3.

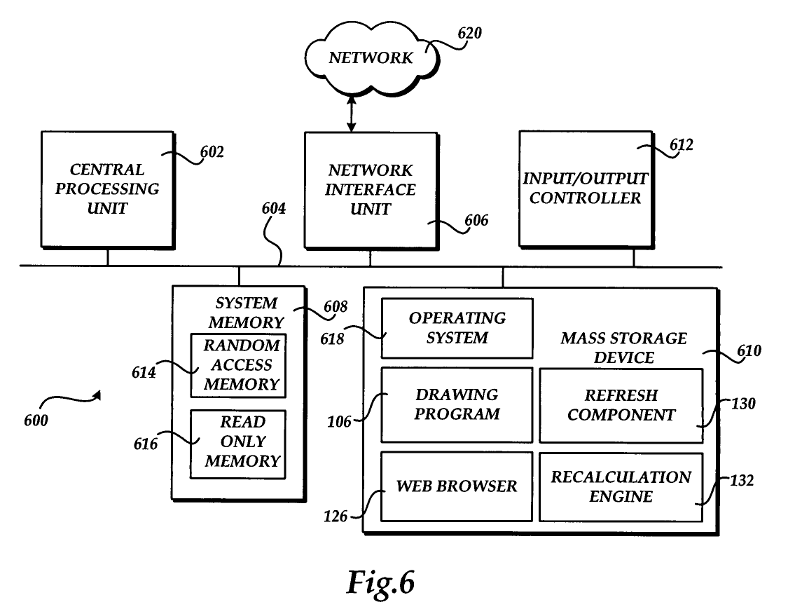

FIG. 6 shows an illustrative computer architecture for a computer 600 capable of executing the software components described herein for recalculating vector graphics on a server computer 104 in the manner presented above. The computer architecture shown in FIG. 6 illustrates a conventional desktop, laptop, or server computer and may be utilized to execute the software components presented herein described as executing on the client computer 102 or the server computer 104.

The computer architecture shown in FIG. 6 includes a central processing unit 602 (“CPU”), a system memory 608, including a random access memory 614 (“RAM”) and a read-only memory (“ROM”) 616, and a system bus 604 that couples the memory to the CPU 602. A basic input/output system containing the basic routines that help to transfer information between elements within the computer 600, such as during startup, is stored in the ROM 616. The computer 600 further includes a mass storage device 610 for storing an operating system 618, application programs, and other program modules, which are described in greater detail herein.

The mass storage device 610 is connected to the CPU 602 through a mass storage controller (not shown) connected to the bus 604. The mass storage device 610 and its associated computer-readable media provide non-volatile storage for the computer 600. Although the description of computer-readable media contained herein refers to a mass storage device, such as a hard disk or CD-ROM drive, it should be appreciated by those skilled in the art that computer-readable media can be any available computer storage media that can be accessed by the computer 600.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 600.

According to various embodiments, the computer 600 may operate in a networked environment using logical connections to remote computers through a network such as the network 620. The computer 600 may connect to the network 620 through a network interface unit 606 connected to the bus 604. It should be appreciated that the network interface unit 606 may also be utilized to connect to other types of networks and remote computer systems. The computer 600 may also include an input/output controller 612 for receiving and processing input from a number of other devices, including a keyboard, mouse, or electronic stylus (not shown in FIG. 6). Similarly, an input/output controller may provide output to a display screen, a printer, or other type of output device (also not shown in FIG. 6).

As mentioned briefly above, a number of program modules and data files may be stored in the mass storage device 610 and RAM 614 of the computer 600, including an operating system 618 suitable for controlling the operation of a networked desktop, laptop, or server computer. The mass storage device 610 and RAM 614 may also store one or more program modules. In particular, the mass storage device 610 and the RAM 614 may store the drawing program 106, the Web browser 126, the refresh component 130, and the recalculation engine 132, each of which was described in detail above with respect to FIGS. 1-5B. The mass storage device 610 and the RAM 614 may also store other types of program modules.

Based on the foregoing, it should be appreciated that technologies for recalculating vector graphics on a server computer are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for server-based recalculation of a vector representation of a drawing, the method comprising:
storing a published drawing at a server computer, the published drawing comprising a formula, the vector representation of the drawing, and data identifying a binding between a shape within the drawing and external data;
receiving at the server computer a request to view the published drawing; and
in response to the request, obtaining an updated value for the external data,
evaluating the formula with the updated value for the external data to generate an updated value for an attribute of the shape, and
updating a portion of the vector representation of the drawing with the updated value for the attribute of the shape.

2. The method of claim 1, wherein the vector representation of the drawing is represented in a markup language, and wherein updating a portion of the vector representation of the drawing with the updated value for the attribute of the shape comprises updating an element within the markup language with the updated value for the attribute.

3. The method of claim 1, wherein the formula comprises a server-optimized formula expressed in a post-fix notation using a markup language.

4. The method of claim 1, wherein evaluating the formula with the updated value for the external data to generate an updated value for an attribute of the shape comprises:
parsing the formula into tokens; and
for each token, determining whether the token is a binding to a data value, and obtaining the data value and placing the data value on a stack in response to determining that the token is a binding to a data value.

5. The method of claim 4, wherein the formula comprises a server-optimized formula, and wherein evaluating the server-optimized formula with the updated value for the external data to generate an updated value for an attribute of the shape further comprises:
for each token, determining whether the token represents a reference to a formula and, in response to determining that the token represents a reference to a formula, obtaining a value for the formula and placing the value for the formula on the stack.

6. The method of claim 5, wherein evaluating the server-optimized formula with the updated value for the external data to generate an updated value for an attribute of the shape further comprises:
for each token, determining whether the token represents a function and, in response to determining that the token represents a function, determining whether the function requires one or more parameters and, in response to determining that the function requires one or more parameters, obtaining the parameters from the stack, evaluating the function with the parameters, and placing a result of the evaluation of the function on the stack.

7. The method of claim 6, further comprising in response to determining that the function does not require one or more parameters:
evaluating the function; and
placing a result of the evaluation of the function on the stack.

8. The method of claim 7, further comprising:
determining whether each token has been evaluated; and
in response to determining that each token has been evaluated, retrieving a value from the stack as the updated value for the attribute of the shape.

9. A method for server-based recalculation of a vector representation of a drawing, the method comprising:
receiving a request to publish a drawing to a server computer, the drawing comprising a shape having an attribute defined by a formula that references external data;
in response to the request, converting the formula to a server-optimized formula, generating a vector representation of the drawing, and generating a published drawing for publication to the server computer, the published drawing comprising the server-optimized formula, the vector representation of the drawing, and data identifying a binding between the shape and the external data; and
publishing the published drawing to the server computer.

10. The method of claim 9, wherein converting the formula to a server-optimized formula comprises expressing the server-optimized formula in a post-fix notation using an extensible markup language.

11. The method of claim 9, wherein converting the formula to a server-optimized formula comprises determining whether the formula is reducible to a constant, and reducing the formula to a constant in response to determining that the formula is reducible to a constant.

12. The method of claim 9, wherein converting the formula to a server-optimized formula comprises:
parsing the formula into one or more tokens; and
determining whether each token comprises a function not supported by the server computer, and reducing each token that comprises a function not supported by the server computer to a constant and adding the constant to the server-optimized formula.

13. The method of claim 12, wherein converting the formula to a server-optimized formula further comprises:
determining whether each token comprises a jump, and adding each jump to the server-optimized formula.

14. The method of claim 13, wherein converting the formula to a server-optimized formula further comprises:
determining whether each token comprises a constant, and adding each constant to the server-optimized formula.

15. The method of claim 14, wherein converting the formula to a server-optimized formula further comprises:
determining whether each token comprises a reference to the external data, and publishing data identifying the reference to the external data to the server-optimized formula.

16. A computer storage medium having computer executable instructions stored thereon which, when executed by a computer, cause the computer to:
store a published drawing, the published drawing comprising a formula, a vector representation of a drawing, and data identifying a binding between a shape within the drawing and external data;
receive a request to view the published drawing; and
in response to receiving the request, to obtain an updated value for the external data, to evaluate the formula with the updated value for the external data to generate an updated value for an attribute of the shape, and to update a portion of the vector representation of the drawing with the updated value for the attribute of the shape.

17. The computer storage medium of claim 16, wherein the vector representation of the drawing is represented in a markup language.

18. The computer storage medium of claim 17, wherein the server-optimized formula is expressed in a post-fix notation using the markup language.

19. The computer storage medium of claim 18, wherein updating a portion of the vector representation of the drawing with the updated value for the attribute of the shape comprises updating an element within the markup language with the updated value for the attribute of the shape.

20. The computer storage medium of claim 19, wherein the formula comprises a server-optimized formula.
